(19) United States
(12) Patent Application Publication
(10) Pub. No.: US 2026/0077982 A1
(43) Pub. Date: Mar. 19, 2026

(54) METHOD AND SYSTEM FOR EVALUATING A RETRACTION LOAD FOR A WINCH HOOK RETENSION SYSTEM

(71) Applicant: FCA US LLC, Auburn Hills, MI (US)

(72) Inventor: Ashwin Dharap, Auburn Hills, MI (US)

(21) Appl. No.: 18/886,072

(22) Filed: Sep. 16, 2024

(51) Int. Cl. B66D 1/48

(52) U.S. Cl. CPC B66D 1/485; B66D 2700/01

(57) ABSTRACT

A method and system for analyzing a vehicle winch design includes a preprocessor determining contact locations for winch components from a mesh model. The preprocessor determines load vectors at a winch assembly and counter-vectors at a fairlead based on a relative position of a winch wire and a hook retention location based on a winch load rating. A non-linear analysis system determines plastic strains, deflections, and clearances under the winch load rating based on the contact locations, load vector and counter vector, and communicates the plastic strains, deflections, and clearances to a post processing system. The post processing system compares the plastic strains to strain limit at a post processor, compares the deflection to a deflection limit, compares clearances to a clearance limit and generating a display based on comparing the plastic strains, compares the deflection to the deflection limit and compares clearances to the clearance limit.

### FIELD

The present disclosure relates to a winch for a vehicle, and, more specifically, to a method and system for evaluating retraction loading at a winch hook retention system.

### BACKGROUND

This section provides background information related to the present disclosure which is not necessarily prior art.

More vehicles are capable of off road use. Vehicles like the Jeep Wrangler and Ram pickups have winches available as options. Winches are becoming more popular in sport utility vehicles and pickup trucks due to their utility particularly in off road conditions.

The winch hooks are often stored attached to the vehicle. Winches are powerful and do not have an automatic stop. The area where the hook is stored could be damaged if the full force of the winch is applied while rewinding the winch.

### SUMMARY

This section provides a general summary of the disclosure, and is not a comprehensive disclosure of its full scope or all of its features.

The present system provides details for a winch hook retention determination strategy. The winch hook retention configuration may be analyzed to determine whether the winch hook meets certain design strategies so that damage may not occur when the winch is retracted to the fully retracted position.

In one aspect of the disclosure, a method of verifying a vehicle winch design includes determining, at a preprocessor, contact locations for winch components from a mesh model, determining load vectors at a winch assembly and counter-vectors at a fairlead based on a relative position of a winch wire and a hook retention location based on a winch load rating, determining, at a non-linear analysis system, plastic strains, deflections, and clearances under the winch load rating based on the contact locations, load vector and counter vectors, communicating the plastic strains, deflections, and clearances to a post processing system, comparing the plastic strains to strain limit at a post processor, comparing the deflection to a deflection limit, comparing clearances to a clearance limit and generating a display based on comparing the plastic strains, comparing the deflection to the deflection limit, comparing clearances to the clearance limit.

In another aspect of the disclosure, a method and system for analyzing a vehicle winch design includes a preprocessor determining contact locations for winch components from a mesh model. The preprocessor determines load vectors at a winch assembly and counter-vectors at a fairlead based on a relative position of a winch wire and a hook retention location based on a winch load rating. A non-linear analysis system determines plastic strains, deflections, and clearances under the winch load rating based on the contact locations, load vector and counter vector, and communicates the plastic strains, deflections, and clearances to a post processing system. The post processing system compares the plastic strains to strain limit at a post processor, compares the deflection to a deflection limit, compares clearances to a clearance limit and generating a display based on comparing the plastic strains, compares the deflection to the deflection limit and compares clearances to the clearance limit.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a front end of a vehicle having a winch according to the present disclosure.

FIG. 1B is an enlarged view of the bumper with a winch located therein.

FIG. 1C is a further enlarged view of the bumper and the cable that is controlled by the winch.

FIG. 1D is a simplified perspective view of the winch on the plate.

FIG. 2 is a high level diagrammatic view of a generic processing component that is illustrated in FIG. 3.

FIG. 3 is a high level diagrammatic view of the processing system according to the present disclosure.

FIG. 4 is high level flowchart of the operation of the system.

Corresponding reference numerals indicate corresponding parts throughout the several views of the drawings.

### DETAILED DESCRIPTION

Example embodiments will now be described more fully with reference to the accompanying drawings.

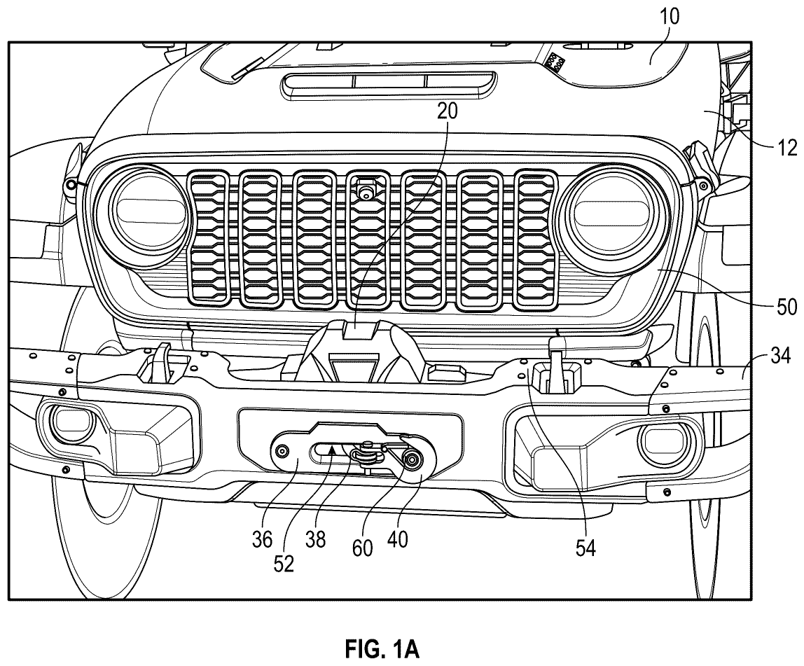

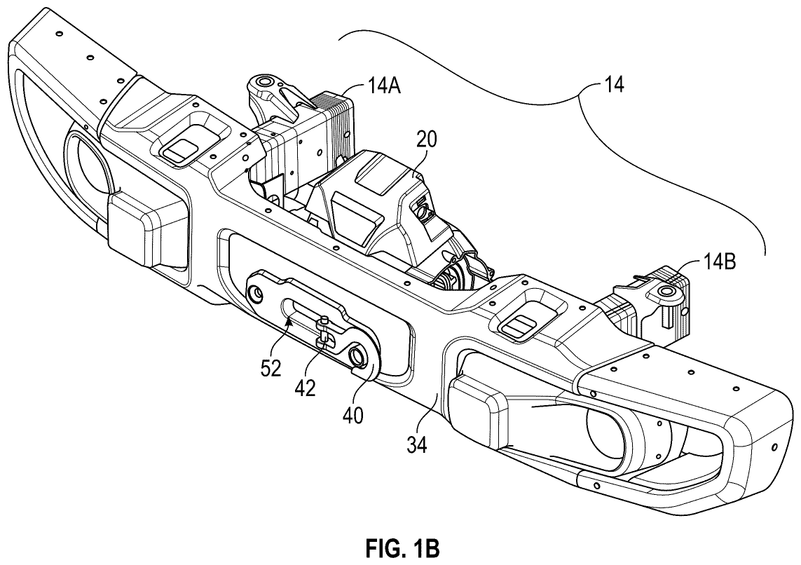

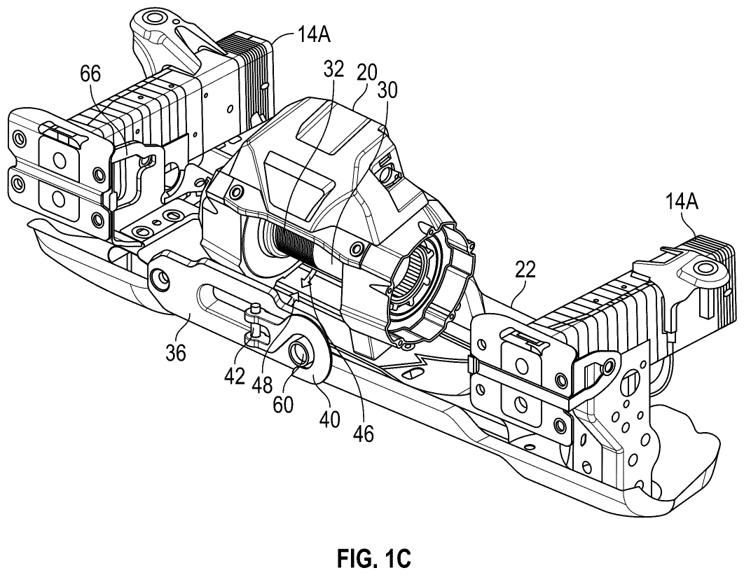

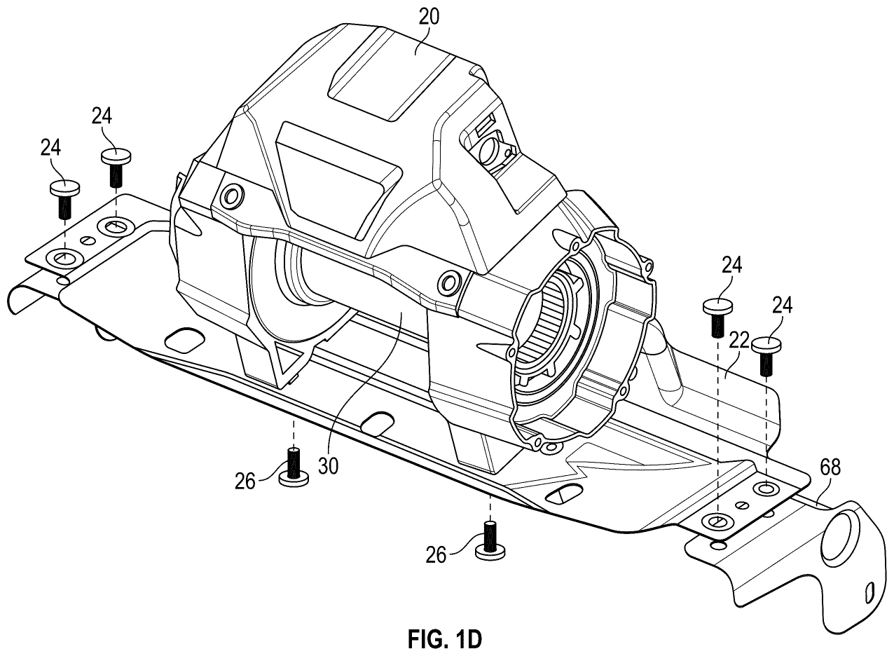

Referring now to FIGS. 1A, 1B and 1C, a vehicle 10, a portion of which is shown, has a body 12 that is coupled to a frame 14 having frame rails 14A and 14B. The vehicle 10 illustrated is a Jeep® Wrangler® which is an off-road vehicle. Off-road vehicles may include a winch 20 that may be ordered as an option on the vehicle. The winch 20 is secured to a plate 22 that extends between the frame rails 14A, 14B at frame fasteners 24. The fasteners 24 may be located at each side of the plates 22. Although two fasteners 24 are illustrated, more than two fasteners may be used. The winch 20 may be secured to the plate 22 by winch plate fasteners 26. Although four fasteners 26 are illustrated, a greater or fewer fasteners 26 may be used. The winch 20 has a cylinder 30 around which a cable 32 is wound. The winch 20 has a positioner (not shown) that is used to move the position of the winding of the cable 32 on the cylinder 30. The cable 32 extends, in this example, through a bumper 34 of the vehicle 10. The bumper 34 is also coupled to the frame 14 of the vehicle 10. The cable 32 extends through a fairlead 36 which is affixed to the bumper 34. The fairlead 36 surrounds the cable 32 when it extends therefrom. The cable 32 has a mount 38 that couples to a hook with pin 42. The pin 42 allows the hook 40 to rotate around an axis defined by the pin 42 relative to the cable mount 38.

As is best illustrated in FIGS. 1C and 1D, a force vector 46 is the force that pulls on the cylinder 30 in a generally axially outward direction. The force vector 46 may be located at any place located on the length of the cylinder 30 including near either longitudinal end. The force vectors 46 referred to below may be perpendicular to the direction of the cylinder 30. However, the cable 32 may extend at different angular directions so therefore the force vectors 46 may not extend perpendicular to the longitudinal axis of the cylinder 30. A counterforce vector 48 is illustrated counter to the force vector 46. The counterforce vector 48 is in the opposite direction from the force vector 46, toward the cylinder 30. The counterforce vector 48 may also be located at various locations relative to the opening 52 of the fairlead 36. That is, the cable mount 38, the hook 40 and/or the pin 42 may have a force inwardly toward the vehicle as illustrated in FIG. 1C by counter vector 48. The winch 20 has a maximum load capacity and a winch rating that is defined by the winch manufacturer. The vehicle 50 may have gaps 54 between the bumper 34 and various pieces of trims such as the front grille 56. Of course, other gaps may be monitored for deflection. That is, the gap 54 may be reduced if portions of the vehicle affected by the forces of the winch are present. Also, the present system is designed to prevent damage to the vehicle and therefore prevent plastic deformation of various parts. The various mounting positions and fasteners, such as fasteners 24, 26 are required not to slip more than a predetermined amount. Any movement must be within a certain range or must be non-plastic meaning the parts will move back into position after the force has been removed.

The hook 40 has a stowing location that, in this example, extends longitudinally forward from the bumper 34 and the fairlead 36. In this example, the stowing location 60 is formed integral with the fairlead 36. It is important for the forces from the winch 20 to not damage the stowing location 60. The stowing location 60 is the location desirable for placing the hook 40 during operation of the vehicle 10 when the winch 20 is not in used.

The plate 22 is secured to the frame rails 14A by a frame bracket 66. The frame bracket 66 may be welded, bolted or integrally formed as part of the frame rail 14A. A bracket 68 shown best in FIG. 1D is positioned below the plate 22 and is attached to the frame rail 14A. The fasteners 24 couple the plate 22 ultimately through any brackets. Of course, different types of brackets may be used. What is important determining slippage at the bolts 24, 26 so that the winch and mounting design generated can be used to reduce or prevent movement.

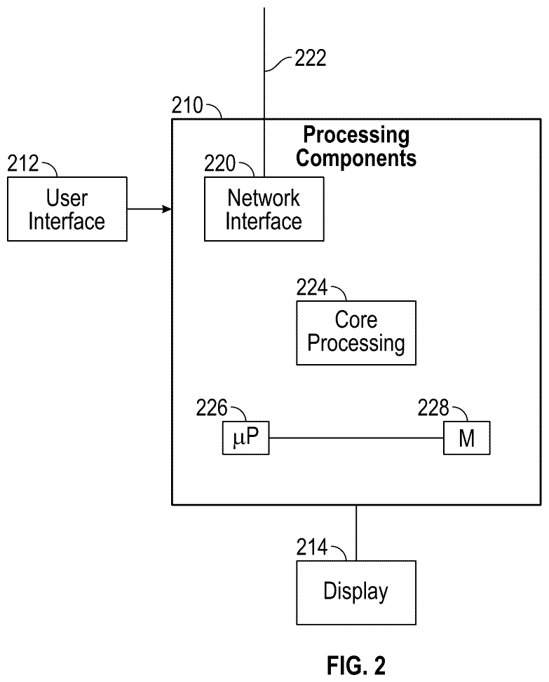

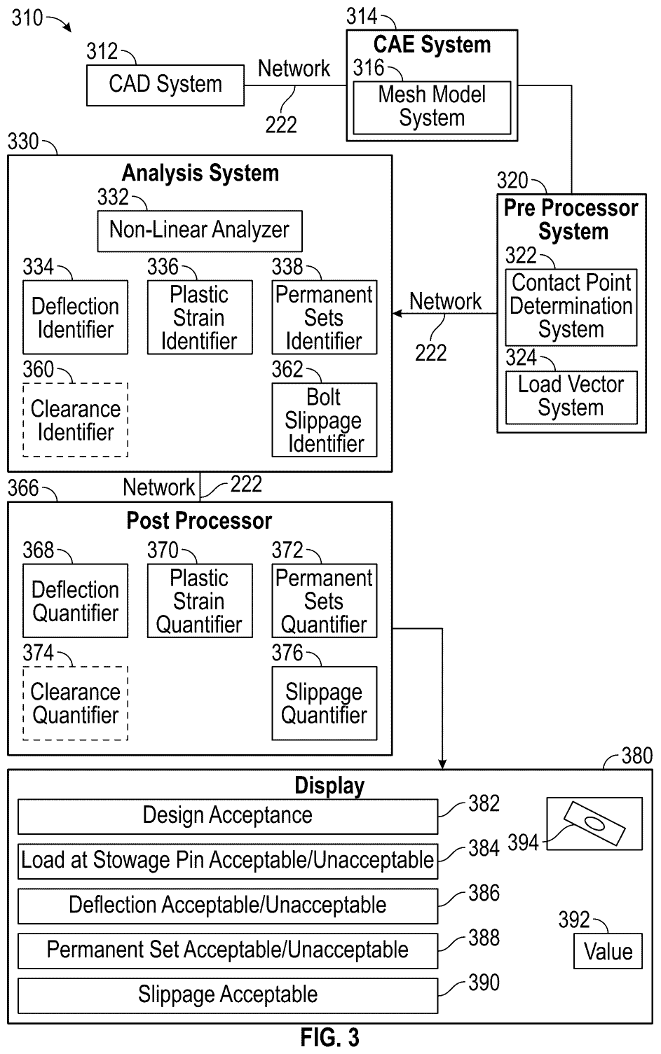

Referring now to FIG. 2, maximum deflections are determined as greater detail below. The present system is a plurality of systems/determinations that ultimately are used to display whether various aspects of the winch design meet certain criteria. In FIG. 2, a generic “processing” component 210 is illustrated. Each of the systems provided in FIG. 3 may be configured in a similar manner. Each of the processing components may include a user interface 212 that is used for inputting data and making various selections. The user interface 212 may be a keyboard, mouse, touch screen or various data entry devices. Each of the processing components 210 may also be coupled to a display 214. The display 214 is used to display data to the user of the processing component. The processing components each have a network interface 220 that is used to communicate through a network. Although one network 222 is illustrated, various types of networks may be used to communicate between the various components. For example, a wired network, a wireless network, Bluetooth®, Bluetooth low energy (BLE), Wi-Fi and the internet may be used.

Each of the processing components 210 described below has core processing with a microprocessor or processor 224 that are used for performing various functions within the system. For example, forming a mesh model, non-linear analysis, determining contact points, deflections, plastic strains and a set may be performed by the core processing of the various systems. The core processing 224 may be powered by microprocessor 226 and a memory 228. The memory 228 may be used to store various data. The memory 228 may also be a non-transitory computer-readable medium including machine-readable instructions that are executable by the processor 226. Each of the processing components below may perform various functions and therefore have various executable instructions.

Referring now to FIG. 3, the winch loading determination system 310 is illustrated in detail using processing components illustrated in FIG. 2 but with greater detail. In this example, a CAD system 312 is used to generate a design for the vehicle. Computer-aided design is commonly used in generating vehicles including all the parts of the vehicle. The computer-aided design system provides a computer-aided design of the vehicle through the network 222 to a computer-aided engineering (CAE) system 314. The CAD design 312 has a winch hook retention location that is provided on the vehicle structure. The mesh model system 316 includes a mesh model of the winch hook retention location that includes how the winch is stored. The mesh model is provided to a preprocessor system 320. The preprocessor system identifies contact locations near the winch hook stowage location 60 and various other contact locations such as the fairlead 36. Multiple contact locations may be determined at the contact point determination system 322 of the preprocessor system 320.

The preprocessor system 320 may also determine load vectors of the system. The load vectors are determined in the load vector system 324. The load vectors are based on the relative positions of the winch cable and the hook retention or stowage location. Equal and opposite loads are formed using the vectors. Examples of vectors were illustrated in FIG. 1C. The load vectors may vary depending on the position of the cable relative to the cylinder 30 as mentioned above in FIG. 1C. That is, the end of the cable may be at the rightmost position of the cylinder, the leftmost position of the cylinder or anyplace in between. Therefore, various vectors at the cylinder and counterforce vectors at the fairlead may be used in this analysis to determine acceptability of a design.

An analysis system 330 is provided with a nonlinear analyzer 332. The nonlinear analyzer 332 obtains the contact points from the preprocessor system and the load vectors and analyzes the data relative to the materials and various other system capacities such as the max load capacity of the winch system. The materials of the vehicle, the bumper, the frame, the winch plate 22, the fasteners 24, 26 may all be considered in the analysis. The analysis system 330 has a deflection identifier 334 that determines a deflector such as a maximum deflector under winch retention loading. The winch retention loading may be based on the rating or maximum load capacity of the winch system. A plastic strain identifier 336 may be used to identify plastic strain in the various components in and around the winch. All of the components illustrated in FIGS. 1B and 1C may be considered in this analysis. A permanent sets identifier 338 may be used for generating a permanent set corresponding to the plastic strain identifier 336. The permanent sets identifier 338 determines a permanent set or plastic deformation where the parts will not move back. A clearance identifier 360 is used to determine a clearance between the bumper and various body parts or body panels of the vehicle. It is desirable to provide low movement of parts and therefore clearances are to be maintained. A bolt slippage identifier 362 identifies bolt slippage at the fasteners 24, 26. When two components bolted together (bolted joints) move too much, the movement is not acceptable. The deflections, plastic strain, permanent sets, bolt slippage and clearances determined in the analysis system 330 are communicated to a post processor 366. The post processor quantifies the deflector in deflection quantifier 368, looks at the quantity of the plastic strain 370, the permanent set quantity or measurement quantifier 372 and a clearance quantifier 374. The deflector quantifier 368 may compare the deflection to a predetermined design value that is acceptable. Likewise, the plastic strain quantifier 370 compares the plastic strain at various locations to known or desired values. The permanent set quantifier 372 determines whether permanent set has been achieved. The clearance quantifier 374 compares the clearances at various locations to clearance minimums.

The post processor 366 may also include a slippage quantifier 376. The slippage quantifier 376 may determine the amount of slippage between various components that are bolted together (bolted joints), such as at the fasteners 24 and 26. That is, the slippage quantifier 376 quantifies the amount of movement between two different components that have fastened together by the fasteners and compares the slippage to a slippage threshold. When the amount of movement of slippage is above the slippage threshold, the movement may be classified as unacceptable.

As mentioned above, each of the systems 312, 320, 330 and 366 may be configured according to that illustrated in FIG. 2 where the core processing 224 represents the individual elements within each of the systems.

The post processor 366 is coupled to a display 380. The display may be used to generate various types of messages to determine the acceptability of the design. In one example, a display area 382 displays “design acceptable”. This is a simple display that states that all of the parameters entered are an acceptable design for the winch. However, specific details may also be provided in the display messages. For example, a display message “load at stowage pin acceptable or unacceptable” may be displayed. This corresponds to the amount of force being applied to the stowage pin may be unacceptable. The pin mount or other configurations may be considered by the vehicle designers. Another example of a message is a deflection message stating that the deflection is unacceptable or unacceptable at 386. A message 388 corresponding to whether the permanent set is acceptable or unacceptable may also be displayed. A slippage message 390 may be used to generate a slippage message corresponding to whether the amount of slippage is acceptable or unacceptable. Each of the displays may also have a corresponding value at a value display 392. A model display 394 may have colored or highlighted areas identifying areas that need improvement.

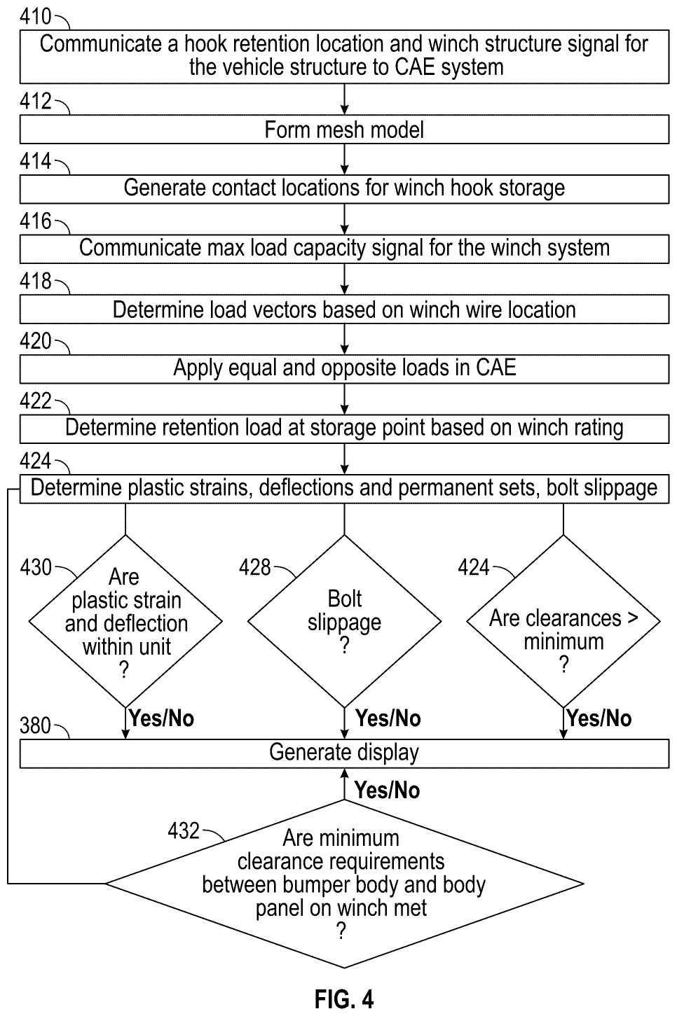

Referring now to FIG. 4, a method of operating the system is set forth. In step 410, a hook retention location and wind structure signal before the vehicle structure are communicated to the CAE system from a CAD system through a network. The signals include the various relationship of the components of the vehicle and the winch including the bumper, the plate, the fasteners and the frame. In step 412, a mesh model is formed. The mesh model corresponds to the relationship of that area of the vehicle. A mesh model of the entire vehicle is not required. The mesh model again may include the components such as the winch, the plate, the fasteners and the portion of the frame in the front of the vehicle including the bumper and fairlead along with a cable and cylinder relative to the winch. In step 414, the contact locations for the winch hook stowage and the various components of the winch hook including the pin, the cable mount and the cable itself are determined. In step 416, the maximum load capacity of the winch is communicated by a maximum load capacity signal. This may be determined by the manufacturer of the winch system in step 416. In step 418, the load vectors based on the winch wired location are determined. The load vector is also based on the position of the stowage location for the hook. In step 420, equal and opposite loads are determined as the vectors in determining the load vectors. The load vectors being equal and opposite are load vectors at the winch cylinder as well as at the contact locations at the fairlead where the pin, mount or hook touches the fairlead. In step 422, the retention load is determined at the stowage point based upon the winch rating. That is, based upon the maximum load capacity of the winch system, the retention load at the stowage point is determined.

In step 424, the mesh model is used to identify then quantify various measurements of the system. That is, various measurements are determined such as plastic strains, deflectors, permanent sets and position of bolts for determining slippage. After step 424, various comparisons are quantified and compared to determine whether the various determinations in step 424 are within various limits. That is, the various clearances are determined whether they are greater than clearance minimums or clearance requirements established by vehicle designers in step 426. In step 428, the bolt slippage is compared to a bolt slippage threshold. In step 430, the plastic strain and deflections are determined whether they are less than plastic strain thresholds and deflection thresholds, respectively. In step 432, the minimum clearance between the bumper components and the body panels are determined by comparison to a clearance threshold. The results of the comparisons in steps 426-432 may be generated on the display 380 as set forth above.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method comprising:
determining, at a preprocessor, contact locations for winch components from a mesh model;
determining load vectors at a winch assembly and counter-vectors at a fairlead based on a relative position of a winch wire and a hook retention location based on a winch load rating;
determining, at a non-linear analysis system, plastic strains, deflections, and clearances under the winch load rating based on the contact locations, load vector and counter vectors;
communicating the plastic strains, deflections, and clearances to a post processing system;
comparing the plastic strains to strain limit at a post processor;
comparing the deflection to a deflection limit;
comparing clearances to a clearance limit; and
generating a display based on comparing the plastic strains, comparing the deflection to the deflection limit, comparing clearances to the clearance limit.

2. The method of claim 1 wherein generating the display corresponds to generating a display corresponds to an acceptable winch design.

3. The method of claim 1 wherein determining the contact point at a stowage location.

4. The method of claim 1 wherein determining the contact point at the fairlead.

5. The method of claim 1 wherein determining the clearance comprises determining a minimum clearance.

6. The method of claim 5 wherein determining the minimum clearance comprises determining clearance requirements between a bumper and body panels or winch.

7. The method of claim 1 further comprising determining bolt slippage at the non-linear analysis system.

8. The method of claim 7 wherein determining bolt slippage comprises determining bolt slippage for bolted joints during a winch retention loading within the mesh model.

9. The method of claim 7 wherein determining bolt slippage at winch plate fastener at the winch.

10. The method of claim 7 wherein determining bolt slippage at winch plate fastener at a vehicle frame.

11. A system comprising:
a preprocessor determining contact locations for winch components from a mesh model;
the preprocessor determining load vectors at a winch assembly and counter-vectors at a fairlead based on a relative position of a winch wire and a hook retention location based on a winch load rating;
a non-linear analysis system determining plastic strains, deflections, and clearances under the winch load rating based on the contact locations, load vector and counter vector, and communicating the plastic strains, deflections, and clearances to a post processing system;
the post processing system comparing the plastic strains to strain limit at a post processor, comparing the deflection to a deflection limit, comparing clearances to a clearance limit and generating a display based on comparing the plastic strains, comparing the deflection to the deflection limit, comparing clearances to the clearance limit.

12. The system of claim 11 wherein the display corresponds to an acceptable winch design.

13. The system of claim 11 wherein the contact point comprises a stowage location.

14. The system of claim 11 wherein the contact points comprise the fairlead.

15. The system of claim 11 wherein the clearance comprises a minimum clearance.

16. The system of claim 15 wherein the minimum clearance comprises the clearance between a bumper and body panels or winch.

17. The system of claim 11 wherein the non-linear analysis system determines bolt slippage at the non-linear analysis system.

18. The system of claim 17 wherein the bolt slippage comprises bolt slippage for bolted joints during a winch retention loading within the mesh model.

19. The system of claim 17 wherein determining the bolt slippage at winch plate fastener at the winch.

20. The system of claim 17 wherein the bolt slippage is at winch plate fastener at a vehicle frame.
